(19) United States
(12) Patent Application Publication
(10) Pub. No.: US 2016/0203175 A1
(43) Pub. Date: Jul. 14, 2016

(54) A SYSTEM AND METHOD FOR MANAGING PARTNER FEED INDEX

(71) Applicant: YANDEX EUROPE AG, Luzern (CH)

(72) Inventors: Dmitry Igorevich KACHMAR, Saint-Petersburg (RU); Vadim Aleksandrovich TCESKO, Saint-Petersburg (RU)

(21) Appl. No.: 14/912,455

(22) PCT Filed: May 29, 2014
(86) PCT No.: PCT/IB14/61823

§ 371 Date: Feb. 17, 2016

(30) Foreign Application Priority Data
Aug. 29, 2013 (RU) 2013140367

(51) Int. Cl. G06F 17/30

(52) U.S. Cl. CPC G06F 17/30345; G06F 17/30486; G06F 17/30321; G06F 17/30569; G06F 17/30424; G06F 17/30598

(57) ABSTRACT

There is disclosed a method of operating a partner feed index. The method may be executable at a server. The method comprises receiving an updated-partner-feed; determining a partition associated with the updated-partner-feed, the partition including a first-prior-partner-feed and a second-prior-partner-feed, the first-prior-partner-feed and the second-prior-partner-feed having been grouped into the partition based on a characteristic shared by the first-prior-partner-feed and the second-prior-partner-feed; responsive to the updated-partner-feed being indicative of a difference with the first-prior-partner-feed and the second-prior-partner-feed, updating the partition based on the updated-partner-feed.

### CROSS-REFERENCE

The present application claims convention priority to Russian Utility Model Application No. 2013140367, filed on Aug. 29, 2013, entitled “ [symbol] [symbol] [symbol] [symbol] [symbol] ”. This application is incorporated by reference herein in its entirety.

### FIELD

The present technology relates to search engines in general and specifically to a system and method for managing partner feed index.

### BACKGROUND

Users access Internet for various reasons. Generally speaking, users access the Internet with an outlook to obtain certain content (information, images, applications, etc). This certain content may be work related, such as for example, if a particular user is conducting a market research on a competitor. This certain content can also be personal—such as for example, doing research on a destination for a vacation. Naturally, some content available on the Internet can be both of a business and of a personal value. For example, a given user may be interested in stock information both for the purposes of her business and for personal investment purposes.

In certain circumstances, a given user may be interested, for example, in purchasing a used car. The given user may, therefore, access the Internet in order to browse advertisements (also colloquially referred to as “ads” or “postings” for short) associated with used cars available for sale. There are many options available for the user to search for such information. For example, one user located in New York, may access a search engine and type in a query “Used Cars for Sale, New York”. Another user may access one of the multiple available dedicated post boards (such as “Craiglist” or “Kijiji”) and browse the relevant sections of the post boards. Yet another user may access an aggregator of advertisement feeds, the aggregator being responsible for aggregating advertisement feeds from several sources.

U.S. Pat. No. 8,447,120 teaches a technology in which an image retrieval system is updated incrementally as new image data becomes available. Updating is incrementally performed and only triggered when the new image data is large enough or diverse enough relative to the image data currently in use for image retrieval. Incremental updating updates the leaf nodes of a vocabulary tree based upon the new image data. Each leaf node's feature frequency is evaluated against upper and/or lower threshold values, to modify the nodes of the tree based on the feature frequency. Upon completion of the incremental updating, a server that performed the incremental updating is switched to an active state with respect to handling client queries for image retrieval, and another server that was actively handling client queries is switched to an inactive state, awaiting a subsequent incremental updating before switching back to active state.

US patent publication 2003/0101183 discloses a reverse index useful for identifying documents in information retrieval searches may be used concurrently for indexing while it is updated with new documents. Interruption to the use of the index is kept to a manageable level by partitioning the index and updating only single partitions of the index at a given time and further by bifurcating the index into a high speed supplemental portion that may be corrected concurrently on a real-time basis and which is periodically merged with the larger main portion. These two structures are merged during reading after brief locking, with pointer redirection.

### SUMMARY

It is an object of the present technology to ameliorate at least some of the inconveniences present in the prior art.

In one aspect, implementations of the present technology provide a method of operating a partner feed index. The method may be executable at a server. The method comprises receiving an updated-partner-feed; determining a partition associated with the updated-partner-feed, the partition including a first-prior-partner-feed and a second-prior-partner-feed, the first-prior-partner-feed and the second-prior-partner-feed having been grouped into the partition based on a characteristic shared by the first-prior-partner-feed and the second-prior-partner-feed; responsive to the updated-partner-feed being indicative of a difference with the first-prior-partner-feed and the second-prior-partner-feed, updating the partition based on the updated-partner-feed.

In some implementations, the method further includes updating a search index based on the updated partition. Updating of the search index may include determining a portion of the search index associated with the updated portion of the partition. In some implementations, the server only re-indexes the portion of the search index associated with the updated portion of the partition.

In some implementations, the method further includes preparing the updated portion of the partition for indexing prior to updating a search index. Such preparing may comprise one or more of: (i) de-serializing; (ii) unifying; (iii) validating the partition by checking against business logic; (iv) image processing; (v) calculating static relevancy; (vi) clustering the advertisements; (vii) validation of the cluster volume and (viii) serialization of the processed partitions.

In some implementations, the server only updates the portion of the partition associated with the updated-partner-feed.

In some implementations, wherein where the updated-partner-feed is being indicative of one of the first-prior-partner-feed and the second-prior-partner-feed being no longer active, the method comprises removing the respective one of the first-prior-partner-feed and the second-prior-partner-feed. Where the updated-partner-feed is being indicative of a new partner feed being different from the first-prior-partner-feed and the second-prior-partner-feed, the method further comprises creating a new partner feed in the partition containing the first-prior-partner-feed and the second-prior-partner-feed. Where the updated-partner-feed is being indicative of one of the first-prior-partner-feed and the second-prior-partner-feed having been changed, the method further comprises updating the respective one of the first-prior-partner-feed and the second-prior-partner-feed.

In some implementations, the updated-partner-feed is implemented as an XML feed. The updated-partner-feed, the first-prior-partner-feed and the second-prior-partner-feed can be representative of advertisements.

In another aspect, implementations of the present technology provide a system for operating a partner feed index, system comprising a feed processing apparatus. The feed processing apparatus is configured to: receive an updated-partner-feed; determine a partition associated with the updated-partner-feed, the partition including a first-prior-partner-feed and a second-prior-partner-feed, the first-prior-partner-feed and the second-prior-partner-feed having been grouped into the partition based on a characteristic shared by the first-prior-partner-feed and the second-prior-partner-feed; responsive to the updated-partner-feed being indicative of a difference with the first-prior-partner-feed and the second-prior-partner-feed, update the partition based on the updated-partner-feed.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the non-limiting embodiments of the present technology, as well as other aspects and further features thereof, reference is made to the following description which is to be used in conjunction with the accompanying drawings, where:

FIG. 1 is a schematic diagram depicting a system 100, the system 100 being implemented in accordance with non-limiting embodiments of the present technology.

FIG. 2 depicts a schematic representation of content of a first partner message transmitted between components of the system 100 of FIG. 1.

FIG. 3 depicts a schematic representation of data stored within a persistent storage 300 maintained within a processed partner feeds database 132 of the system 100 of FIG. 1.

FIG. 4 depicts a schematic flow chart of a method 400, the method executable within the system 100 of FIG. 1, the method 400 being implemented in accordance with non-limiting embodiments of the present technology.

FIG. 5 depicts a non-limiting embodiment of a persistent storage 300′, the persistent storage 300′ having been updated as part of executing a step 406 of the method 400 of FIG. 4.

### DETAILED DESCRIPTION

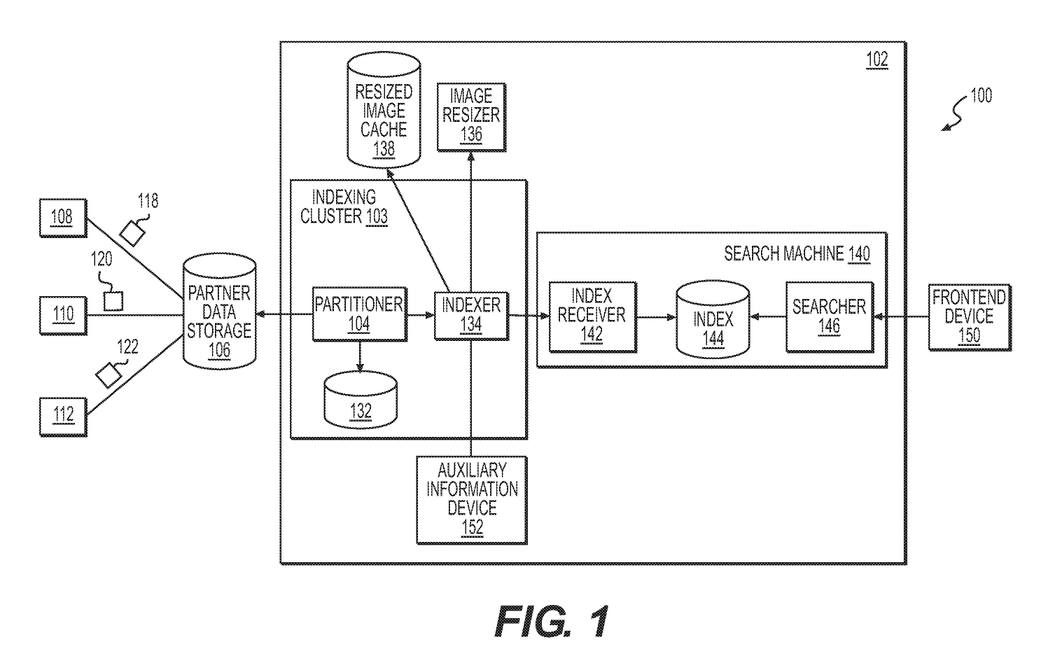

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises a feed processing device 102. The feed processing device 102 can be implemented as a server (not separately numbered). Alternatively, the feed processing device 102 can be implemented in a distributed manner, whereby some or all of the components of the feed processing device 102 to be described herein below may be implemented on separate computing apparatuses. As an example, the non-limiting embodiment of the feed processing device 102 can be implemented as a Dell™ PowerEdge™ Server running the Microsoft™ Windows Server™ operating system. Needless to say, the feed processing device 102 can be implemented in any other suitable hardware and/or software and/or firmware or a combination thereof.

The feed processing device 102 l comprises an indexing cluster 103. The indexing cluster 103 includes a partitioner 104. Generally speaking, the partitioner 104 is configured to maintain a processed partner feeds database (to be described below) with partner feeds, to receive updated partner feeds, to initiate indexing of the updated partner feeds, etc. To that end, the partitioner 104 comprises or, as depicted in FIG. 1, has access to a partner data storage 106. Now it should be noted that even though in the non-limiting embodiment of the present technology depicted in FIG. 1, the partner data storage 106 comprises a single storage entity, in alternative non-limiting embodiments of the present technology, the partner data storage 106 may be implemented in a distributed manner. Just as an example, in alternative non-limiting embodiments of the present technology, the partner data storage 105 may be implemented as a plurality of data storage devices (not depicted), each of the plurality of data storage devices may be associated, for example, with a particular partner and the associated partner's feeds data or a subset of partners and associated partners subsets' feeds.

It should also be noted that the term “partner” in the term “partner data storage” or “partner feed” should not be used to imply any sort of special relationship between the source of the data in the partner data storage 106 and an operator operating the feed processing device 102. For example, in some non-limiting embodiments of the present technology, the partner data storage 106 may store data from multiple sources, each source not having any particular relationship with the operator operating the feed processing device 102. In those examples, each source may upload their data onto the partner data storage 106 without having to first enter into any business relationship with the operator operating the feed processing device 102.

In other non-limiting embodiments of the present technology, the partner data storage 106 may store data from multiple sources, each source (or at least some of the sources) having entered into an arrangement with the operator operating the feed processing device 102. How this arrangement is structured is not particularly limited and may include an unpaid subscription by the source of data, paid subscription by the source of data, subscription in exchange for provision of banner ads or even a “reverse payment” subscription, where the source of data gets paid for uploading their data onto the partner data storage 106.

Furthermore, in some non-limiting embodiments of the present technology, the partner data storage 106 may be under ownership and/or operation and/or control of the same entity as the operator operating the feed processing device 102. In alternative non-limiting embodiments of the present technology, the partner data storage 106 may be under ownership and/or operation and/or control of an entity different than the one controlling the operator of the feed processing device 102. In those examples, the partner data storage 106 may be under ownership and/or operation and/or control of one of the entities uploading the data onto the feed processing device 102 (who would act as an aggregator of feeds from various sources) or a third party entity, who would act as an aggregator of data from multiple sources.

The data maintained on the partner data storage 106 may take many forms. Therefore, the content of the partner data storage 106 or the partner feeds distributed therefrom (as will be described herein below) does not have to be construed as a limitation of embodiments of the present technology. In some non-limiting embodiments of the present technology, data maintained within the partner data storage 106 can be advertisement for various goods or services. As an example and merely for the purposes of illustrating various non-limiting embodiments of the present technology, it shall be assumed that the partner data storage 106 maintains data representative of advertisements for used cars for sale. Needless to say, data stored in the partner data storage 106 and the associated partner feeds may include news feeds, stock exchange feed, RSS feeds and the like.

Also depicted within FIG. 1 are a first partner 108, a second partner 110 and a third partner 112, all of them being desirous of providing partner feeds containing advertisements for used cars for sale. It should be noted that the number of partners potentially present within the system 100 is not particularly limited. Given the example mentioned above, it shall be assumed that each of the first partner 108, the second partner 110 and the third partner 112 is desirous of uploading their respective advertisements in respect to the used car sales onto the partner data storage 106.

In some non-limiting embodiments of the present technology, each of the first partner 108, the second partner 110 and the third partner 112 is configured to transmit to the partner data storage 106 a respective feed containing details of the advertisement, the respective feed being a first partner feed 118, a second partner feed 120 and a third partner feed 122. In some non-limiting embodiments of the present technology, each of the first partner feed 118, the second partner feed 120 and the third partner feed 122 can be implemented as an Extensible Markup Language (XML) feed. In other non-limiting embodiments of the present technology, each of the first partner feed 118, the second partner feed 120 and the third partner feed 122 can be implemented in any other suitable commercially available or proprietary format.

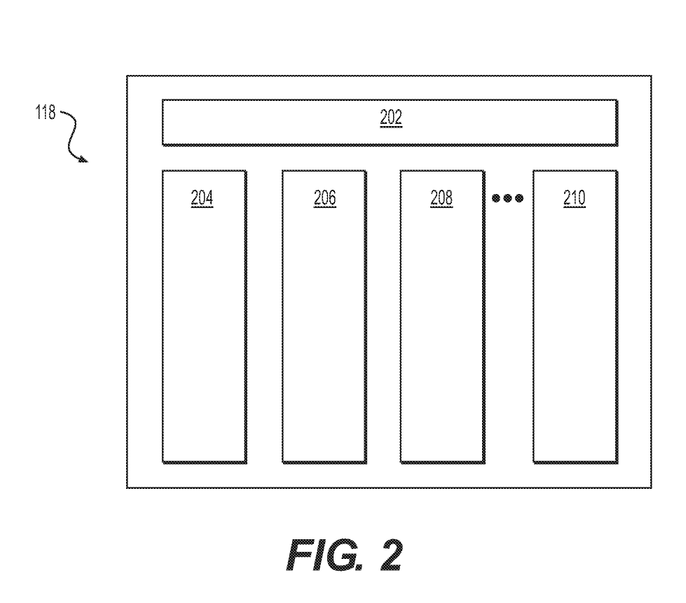

The content of each of the first partner feed 118, the second partner feed 120 and the third partner feed 122 is not particularly limited and will naturally depend on the type of information being maintained within the partner data storage 106. An example of the content of the first partner feed 118, the second partner feed 120 and the third partner feed 122 will be provided with reference to FIG. 2, which depicts the content of the first partner feed 118 (as an illustration only). It should be noted that the remainder of the second partner feed 120 and the third partner feed 122 can be executed in substantially similar (but not necessarily identical) manner.

The first partner feed 118 includes a source indicator 202, which is generally indicative of the identity of the source sending the first partner feed 118. In this example, the source indicator 202 is indicative of the first partner 108 being the source of the first partner feed 118. In some non-limiting embodiments of the present technology, the source indicator 202 can comprise a unique identifier associated with the source of the partner feed, a company name of the source of the partner feed or a Universal Resource Locator (URL) associated with the location of the particular advertisement on the partner web site with which the first partner feed 118 is associated with.

The first partner feed 118 further includes a first advertisement portion 204, a second advertisement portion 206, a third advertisement portion 208^{th} and an N^{th} advertisement portion 210. Naturally, the number of advertisement portions 204, 206, 208, 210 contained in the first partner feed 118 is not limited to those illustrated here. As such, it is foreseeable, that a given one of the first partner feed 118 may include a single instance of the first advertisement portion 204—hence being dedicated exclusively to a single advertisement. On the other end of the spectrum, the given one of the first partner feed 118 may include a plurality of N^{th} advertisement portions 210, each dedicated to the respective advertisement. Therefore, it can be said that the given one of the first partner feeds 118 may be representative of a single advertisement or multiple advertisements.

The content of each of the first advertisement portion 204, the second advertisement portion 206, the third advertisement portion 208 and the N^{th} advertisement portion 210 will depend on the nature of the advertisement, of course. Recalling that in the example we are using here, the advertisement if for used cars for sale, each of the first advertisement portion 204, the second advertisement portion 206, the third advertisement portion 208 and the N^{th} advertisement portion 210 will include some or all of: (i) year of the car; (ii) make of the car;

(iii) model of the car; (iv) sales price; (v) an image or images of the car; and (vi) additional information about the car.

It should be noted that within the embodiments illustrated above, the first partner feed 118 is associated with a single feed provider (for example, the first partner 108). Naturally, it is possible that a given one of the first partner feed 118, in alternative non-limiting embodiments of the present technology, may in fact be associated with feeds from several partners. As such, it is possible that the given one of the first partner feed 118 may include several ones of the source indicators 202. For example, each source indicator 202 may be associated with the respective one of the first advertisement portion 204, the second advertisement portion 206, the third advertisement portion 208 and the N^{th} advertisement portion 210. Even where the first partner feed 118 is associated with a single feed provider, it may still contain multiple ones of the source indicator 202, each source indicator 202 being associated with the respective one of the first advertisement portion 204, the second advertisement portion 206, the third advertisement portion 208 and the N^{th} advertisement portion 210.

Returning now to the description of FIG. 1, the indexing cluster 103 further includes a processed partner feeds database 132. The processed partner feeds database 132 receives from the partitioner 104 and stores processed partner feeds, as will be described in greater detail herein below. The indexing cluster 103 further comprises an indexer 134. Generally speaking, the purpose of the indexer 134 is to create indexes based on the new processed partner feeds stored in the processed partner feeds database 132 and to update indexes based on the feed updates received from the partner data storage 106.

Even though the indexer 134 is depicted as a single entity, in alternative non-limiting embodiments of the present technology, the indexer 134 can be implemented in a distributed manner. Within those non-limiting embodiments of the present technology, where the indexer 134 is implemented in a distributed manner, the transmission of information between the partitioner 104 and one of the multiple indexers 134 could be implemented by employing load-balancing. In other words, the partitioner 134 may choose one of the available multiple indexers 134 based, for example, on how busy the given one of the multiple indexers 134 is compared to the other ones of the available multiple indexers 134.

Now, the function of the partitioner 104 will be described within the context of the partitioner 104 processing new partner feeds. However, some of the described processes for new partner feeds will apply mutatis mutandis to the receiving and processing updated partner feeds (to be described herein below). The partitioner 104 receives a feed from the partner data storage 106 (the feed having been uploaded to the partner data storage 106 by one or more of the first partner 108, the second partner 110 or the third partner 112). It should be noted that in some non-limiting embodiments of the present technology, the new (or updated) partner feed retrieved from the partner data storage 106 may be representative of information from a single one of the first partner 108, the second partner 110 and the third partner 112. In alternative non-limiting embodiments of the present technology, the new (or updated) partner feed retrieved from the partner data storage 106 may be representative of information from multiple ones of the first partner 108, the second partner 110 and the third partner 112.

In some non-limiting embodiments of the present technology, the partitioner 104 accesses the partner data storage 106 to retrieve the feed. This accessing can be done on a periodic or random basis, such as for example, every 15 minutes, every hour, every day, every week or Monday, Tuesday and Friday of a given week or any combination thereof. These embodiments can be thought of as a “pull” approach. In alternative non-limiting embodiments of the present technology, the partner data storage 106 may transmit the feed to the partitioner 104. This transmission can likewise be done on periodic or random basis, such as for example, every hour, every day, every week or Monday, Tuesday and Friday of a given week or any combination thereof. These embodiments can be thought of as a “push” approach. Naturally, a combination of a pull and push approaches can also be utilized.

Once the partitioner 104 receives the feed, the partitioner 104 parses the received feed into a plurality of advertisements potentially contained therein. Given the example of the first partner feed 118 (FIG. 2), the partitioner 104 extracts the source indicator 202 and then parses the first partner feed 118 into a first advertisement containing the first advertisement portion 204, a second advertisement containing the second advertisement portion 206, a third advertisement containing the third advertisement portion 208; and an N^{th} advertisement containing the N^{th} advertisement portion 210.

The partitioner 104 then executes a unification function of each of the so-generated advertisements. More specifically, the partitioner 104 ensures that each of the advertisement contains key field formatted in the same fashion. The unification function can be particularly useful considering that there is no pre-defined format for the submission of the partner feeds. Naturally, where there is a pre-defined format has been established for the submission of the partner feeds, the unification function may be optionally not executed.

For the purposes of the example being presented herein below, the key fields are “make”, “model” and “year” associated with the used car for sale. Naturally, in those embodiments of the present technology where the advertisement contains other type of subject-matter, the key fields will be implemented differently. It should be also noted that the number of the key fields is not limited. Generally speaking, the number and the content of the key fields will be selected such that the key fields identify the subject matter of the advertisement and allow for partitioning thereof, as will be described momentarily.

Based on the key fields for each of the given advertisement, the partitioner 104 determines a partition where the given advertisement (or, generally, partner feed) should reside. Generally speaking, the “partition” is a collection of advertisements grouped according to a characteristic associated therewith. In this example, the characteristic can be the totality of the year, make and model of a given used car for sale. The partitioner 104 then creates the partitions (i.e. groups advertisements based on the selected characteristic of the key fields) and stores them in the processed partner feeds database 132. It should be noted that the selection of the year, make and model of the given car was used as an example only. It should be expressly understood that any number of the key fields can be used as a characteristic to group advertisements into partitions.

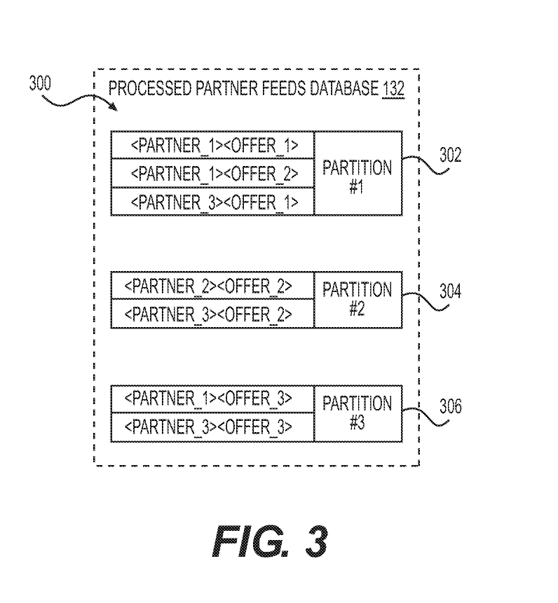

With reference to FIG. 3, there is depicted an example of a persistent storage 300 maintained within the processed partner feeds database 132. Within this illustration, the persistent storage 300 contains three partitions: a first partition 302, a second partition 304 and a third partition 306, the number of the three partitions having been arbitrarily chosen as an example only.

For the purposes of this illustration, it shall be assumed that the first partition 302 has been created based on the following characteristics: “<Year><2011>”, “<Make><Ford>”, “<Model><Escort>”. The second partition 304 has been created based on the following characteristics: “<Year><2009>”, “<Make><BMW>”, “<Model><325>”. The third partition 306 has been created based on the following characteristics: “<Year><2010>”, “<Make><Mazda>”, “<Model><3>”.

Accordingly based on the above characteristics, the following partner feeds have been grouped into the respective partitions. The first partition 302 is populated with the “<partner1><offer 1>” representative of the first offer from the first partner 108, “<partner 1><offer 2>” representative of a second offer from the second partner 110 and “<partner 3><offer 1>” representative of the first offer from the third partner 112.

The second partition 304 is populated with the “<partner 2><offer 2>” representative of the second offer from the second partner 110, “<partner 3><offer 2>” representative of a second offer from the third partner 112.

Finally, the third partition 306 is populated with the “<partner 1><offer 3>” representative of the third offer from the first partner 108 and “<partner 3><offer 3>” representative of a third offer from the third partner 112.

Returning now to the description of FIG. 1, once the partitioner 104 has populated the persistent storage 300 maintained within the processed partner feeds database 132, it transmits the first partition 302, the second partition 304 and the third partition 306 to the indexer 134.

Generally speaking, the purpose of the indexer 134 is to index the partitions (such as, the first partition 302, the second partition 304 and the third partition 306) to create a persistent index, which can be used for searching of the advertisements. In some non-limiting embodiments of the present technology, the indexer 134 is configured to index partitions independent from each other. In other non-limiting embodiments of the present technology, the indexer 134 is configured to index the partitions in parallel. In yet further embodiments of the present technology, the indexer 134 is configured to index at least some of the partitions in parallel and independent from each other.

More specifically, the indexer 134 receives from the partitioner 104, data from the persistent storage 300, namely data from the first partition 302, the second partition 304 and the third partition 306 (this data can be thought of as the “processed partner feeds”).

The indexer 134 can then perform one or more of the following operations. In some non-limiting embodiments of the present technology, the indexer 134 prepares the data for indexing. Namely, the indexer 134 can perform one or more of the following functions: (i) de-serializing; (ii) unifying; (iii) validating the partition by checking against business logic; (iv) image processing; (v) calculating static relevancy; (vi) clustering the advertisements; (vii) validation of the cluster volume and (viii) serialization of the processed partitions.

Next, some of these functions will be described in greater detail.

The indexer 134 can perform the process of de-serialization by first converting the received partner feeds from a compact format suitable for transition over a network into a format more suitable for manipulation, as will be explained in further detail below. In some embodiments, the function of de-serializaiton can be executed by the partitioner 104, when the partner feed is first received. The indexer 134 can additionally perform its own de-serialization function.

The indexer 134 can perform the unifying function by translating the key fields of each of the partner fields to a unified format. Within the embodiments being presented herein, the indexer 134 ensures that all of the make, model and year fields are recorded in the same format. To that end, the indexer 134 may have access to a thesaurus or other databases of synonyms. For those partner feeds that, as part of the key fields, contain words that can not be unified, the indexer 134 can simply ignore those partner feeds. In some embodiments, the function of unification can be executed by the partitioner 104, when the partner feed is first received. The indexer 134 can additionally perform its own unification function.

The indexer 134 performs a validation function, namely validating the partition by checking against business logic. In some non-limiting embodiments of the present technology, the indexer 134 aims to determine if any of the advertisement contained within the first partition 302, the second partition 304 or the third partition 306 are either not real, fraudulent or otherwise should not be displayed to the users performing the searches.

The indexer 134 can perform image processing of the images contained within data stored in the persistent storage 300. In some non-limiting embodiments of the present technology, the indexer 134 processes images by resizing them—for example, by creating an image with lower resolution and/or lower size. The indexer 134 can execute image resizing by accessing an image resizer module 136. The resized images can be stored in a resized image cache 138.

The indexer 134 can perform static relevancy calculation by determining how appropriate a given advertisement within the partner feed is. The indexer 134 can employ numerous algorithms for determining the static relevancy, depending on specific business needs. Just as an example, the indexer 134 can determine how many times a given source of partner feeds has been a source of fraudulent or outdated advertisements.

Furthermore, the indexer 134 can perform clustering of the data maintained within the persistent storage 300. In some non-limiting embodiments of the present technology, as part of the clustering function, the indexer 134 analyzes the data stored within the persistent storage 300 to determine if there are any duplicates. Generally speaking, duplicates may occur where the same advertisement has been submitted twice (or multiple times for that matter), which may occur from time to time when an aggregator has reposted the original advertisement from one of the first partner 108, the second partner 110 and the third partner 112. Naturally, duplicate entries may occur for any other reason. If any duplicates are located as part of the clustering function, the indexer 134 may cause removal of the duplicate entries from the processed partner feeds database 132.

The indexer 134 can further perform validation of the cluster volume by determining if a size of a given partition has exceeded a historical average size of partitions. Finally, the indexer 134 can perform serialization of the processed partitions into format suitable for storage and/or transmission.

Once the indexer 134 has completed processing the data stored in the persistent storage 300, it transmits it to a search machine 140 and, namely, to an index receiver 142 the search machine 140. The index receiver 142 is responsible for receiving the processed partitions from the indexer 134 and to build persistent indexes to enable searching. In some non-limiting embodiments of the present technology, the index receiver 142 first transcodes the received partitions into a search index format, which can be, as an example, the Lucene format or any other suitable commercially available or proprietary format.

Once transcoded, the index receiver 142 builds a search index for partitions in an index storage 144. The search index within the index storage 144 is accessible by a searcher 146 when executing searches upon request from a front end device 150. A non-limiting example of the index maintained by the index storage 144 may be expressed as follows:

```
  1/index
  2 +--v10 (format version 10)
  3 | +-- ...
  4 +--v11 (format version 11)
  5 +--p0 (index for partition #0)
  6 | +--t12345678 (read-only catalogue of Lucene index, created in
  7UNIX time 12345678)
  8 | | +-- ...
  9 | +--t12346789-building (catalogue of Lucene index, built by
10Index Receiver [symbol]   invisible to the Searcher)
        | +-- ...
        +-- ...
```

Also depicted within the illustration of FIG. 1 is an auxiliary information device 152. The auxiliary information device 152 is responsible for obtaining, storing and management of additional information required in administering the processes within the feed processing device 102. Examples of such information that may be obtained, stored and managed by the auxiliary information device 152 include (but are not limited to): catalogues of various cars, dictionaries for translating and unifying the names, currency exchange rates, regional price schemes and the like. Naturally, in other non-limiting embodiments of the present technology, where the partner feeds are associated with data other than used cars for sale, the auxiliary information device 152 can be configured to obtain, store and manage other sort of information.

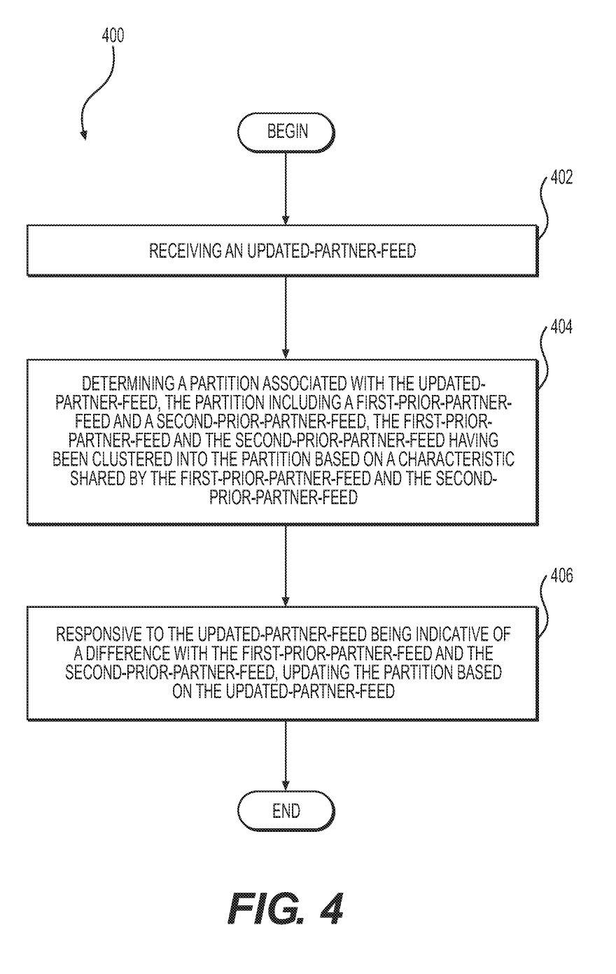

Given the architecture of the system 100 of FIG. 1, it is possible to execute a method of operating a partner feed index. With reference to FIG. 4, there is depicted a schematic block diagram representing steps of a method 400, the method 400 being implemented in accordance with non-limiting embodiments of the present technology. The method 400 can be conveniently executed within the feed processing device 102. To that extent, the feed processing device 102 comprises computer usable information storage medium that includes computer-readable instructions, which when executed, are configured to cause the feed processing device 102 to execute the steps of the method 400.

For the purposes of the discussion to be presented herein below, it shall be assumed that the persistent storage 300 has been populated with the first partition 302, the second partition 304 and the third partition 306, as is depicted in FIG. 3.

Step 402—Receiving an Updated-Partner-Feed

The method 400 begins at step 402, where the partitioner 104 receives an updated-partner-feed. In some non-limiting embodiments of the present technology, step 402 may be executed by means of the partitioner 104 accessing the partner data storage 106 to retrieve the updated-partner-feed. This accessing can be done on periodic or random basis, such as for example, every hour, every day, every week or Monday, Tuesday and Friday of a given week or any combination thereof. These embodiments can be thought of as a “pull” approach. In alternative non-limiting embodiments of the present technology, the partner data storage 106 may transmit the feed to the partitioner 104. This transmission can likewise be done on a periodic or random basis, such as for example, every 15 minutes, every hour, every day, every week or Monday, Tuesday and Friday of a given week or any combination thereof. These embodiments can be thought of as a “push” approach. Needless to say, a combination of the pull and push approaches can be used.

Within the description presented herein the term “updated-partner-feed” shall mean a partner feed that potentially has updated information in regard to the various advertisements maintained within the persistent storage 300. The updated information may take form of new advertisements. The updated information can also take form of deleted advertisements—in other words, advertisements no longer available. Finally, the updated information can take form of changes to the existing advertisements (such as, for example, changed selling price, updated images and the like). Also, it should be noted that the updated-partner-feed can be associated with a single one of the first partner 108, the second partner 110 or the third partner 112. Alternatively, the updated-partner-feed can be associated (and thus potentially contain updates) for more than one of the first partner 108, the second partner 110 or the third partner 112.

The method 400 then proceeds to execution of step 404.

Step 404—Determining a Partition Associated with the Updated-Partner-Feed, the Partition Including a First-Prior-Partner-Feed and a Second-Prior-Partner-Feed, the First-Prior-Partner-Feed and the Second-Prior-Partner-Feed Having Been Grouped into the Partition Based on a Characteristic Shared by the First-Prior-Partner-Feed and the Second-Prior-Partner-Feed

The method 400 then, at step 404, determines a partition associated with the updated-partner-feed, the partition including a first-prior-partner-feed and a second-prior-partner-feed, the first-prior-partner-feed and the second-prior-partner-feed having been grouped into the partition based on a characteristic shared by the first-prior-partner-feed and the second-prior-partner-feed. In the illustrated embodiment of the persistent storage of FIG. 3, one of the first partition 302, the second partition 304 and the third partition 306 would be used to determine which partition the updated-partner-feed belongs to. The records maintained therein would be examples of the first-prior-partner feed and the second-prior-partner-feed.

In order to determine the partition, the partitioner 104 first parses the received updated-partner-feed, much akin to what was described above in regard to a new partner feed. By doing so, the partitioner 104 retrieves various advertisements contained within the updated-partner-feed. The partitioner 104 then unifies the key fields, just like was described above.

Based on the so-unified key fields, the partitioner 104 determines one or more partitions associated with the content of the updated-partner-feed. Now, it should be recalled that the various partitions present within the persistent storage 300 have a plurality of partner feeds already stored (i.e. the first-prior-partner feed and the second-prior-partner-feed), the plurality of partner feeds having been grouped according to a characteristic, as has been previously described as part of the operation of the partitioner 104.

Now what this means is that a given partition of the first partition 302, the second partition 304 and the third partition 306 may contain:

(a) the first-prior-partner-feed and the second-prior-partner-feed whereby the updated-partner-feed may be different from both first-prior-partner-feed and the second-prior-partner-feed, thus being indicative of a new advertisement to be placed into the given partition;

(b) the first-prior-partner-feed and the second-prior-partner-feed, whereby one of the first-prior-partner-feed and the second-prior-partner-feed is substantially similar to the updated-partner-feed but with some differences, indicative of the fact that the one of the first-prior-partner-feed and the second-prior-partner-feed needs updating based on the updated-partner-feed;

(c) the first-prior-partner-feed and the second-prior-partner-feed, whereby one of the first-prior-partner-feed and the second-prior-partner-feed is the same as the updated-partner-feed as the updated-partner-feed contains the same advertisement with no changes to be made to the first-prior-partner-feed and the second-prior-partner-feed.

On the other hand, the updated-partner-feed may be indicative that the advertisement that was contained in the prior-version-partner-feed may have been removed (for example, the used car may have sold or the owner may have otherwise changed their mind about selling the car). For example, the updated-partner-feed may not have a portion that corresponds to one of the first-prior-partner-feed and the second-prior-partner-feed, hence indicating that the respective one of the first-prior-partner-feed and the second-prior-partner-feed has been deleted. The updated-partner-feed may thus contain an indication of the fact that one or more of the first-prior-partner-feed and the second-prior-partner-feed need to be removed.

The method 400 then proceeds to execution of step 406.

Step 406—Responsive to the Updated-Partner-Feed being Indicative of a Difference with the First-Prior-Partner-Feed and the Second-Prior-Partner-Feed, Updating the Partition Based on the Updated-Partner-Feed

Next, at step 406, the partitioner 104, responsive to the updated-partner-feed being indicative of a difference with the first-prior-partner-feed and the second-prior-partner-feed, updates the partition based on the updated-partner-feed. As part of the executing step 406, various scenarios are possible.

Where the updated-partner-feed is indicative of the fact that the advertisement contained in the prior-version-partner-feed has been deleted, the partitioner 104 deletes the record in the persistent storage 300, the record that was indicative of the prior-version-partner-feed.

Where the updated-partner-feed is indicative of the fact that the advertisement contained in the prior-version-partner-feed has been changed, the partitioner 104 updates the record in the persistent storage 300, the record that was indicative of the prior-version-partner-feed with the new information.

Where the updated-partner-feed is indicative of the fact that there is a new advertisement to be added to a particular partition, the partitioner 104 creates a new record in the given partition, the new record being indicative of the updated-partner-feed.

Just as an example, it shall be assumed that the updated partner feed contains the following indications. The updated partner feed is indicative of the fact that <Partner 1><Offer 2> has been deleted and of a new offer from the third partner 112, namely <Partner 3><Offer 4>. Therefore, the partitioner 104 determines that the first partition 302 needs to be updated (namely, to remove the <Partner1><Offer 2>.

The partitioner 104 further analyzes the content of the <Partner 1><Offer 4> and namely the key fields thereof (which in this example are year, make and model of the used car for sale). Based on the analysis, it will be assumed that the partitioner 104 has determined that <Partner 1><Offer 4> belongs in the third partition 306. Thus, the partitioner 104 determines that the third partition 306 needs to be updated to create a new entry for the <Partner 1><Offer 4>.

The partitioner 104 then updates only those partitions that need to be updated, namely in this case, the first partition 302 and the third partition 306. In order to determine the exact partition that needs to be updated, the partitioner 104 may execute, as an example, the following function:

(mark: String, model: String, year: Int): PartitionKey =
PartitionKey(math.abs(“%s:%s:%d”.format(mark, model,
year).hashCode) % PARTITION_COUNT)

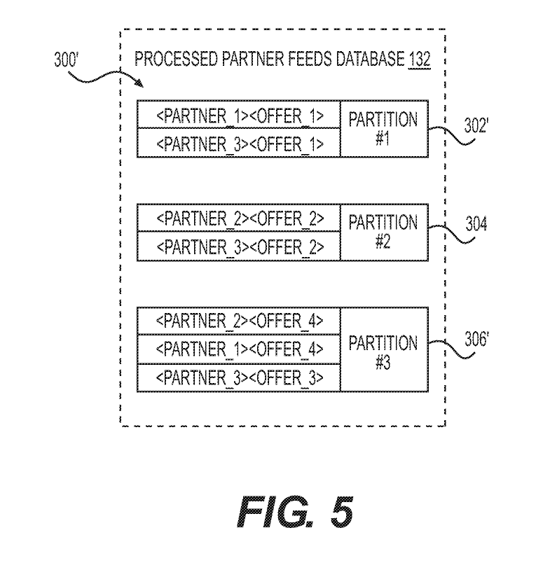

A resultant updated persistent storage 300′ is depicted with reference to FIG. 5. FIG. 5 depicts a non-limiting embodiment of a persistent storage 300′, the persistent storage 300′ having been updated as part of executing the step 406 of the method 400. The persistent storage 300′ includes a first partition 302′ (which is the updated version of the first partition 302), the second partition 304 (which has not been updated from the illustration of FIG. 3) and a third partition 306′ (which is the updated version of the third partition 306).

The first partition 302′ has been updated to remove the indication of the <Partner1><Offer 2> and the third partition 306′ has been updated to include the new advertisement for <Partner 1><Offer 4>. It is noted that the second partition 304 has not been updated—since the updated-partner-feed has not been indicative of any changes to be made to the second partition 304.

Therefore, it can be said that in some non-limiting embodiments of the present technology, as part of executing the step 406, the partitioner 104 only accesses those of the first partition 302, the second partition 304 and the third partition 306 that need updating based on the comparison step made in step 304.

The partitioner 104 then transmits the updated partitions to the indexer 134. In some embodiments of the present technology, the indexer 134 can first perform one or more of the following functions: (i) de-serializing; (ii) unifying; (iii) validating the partition by checking against business logic; (iv) image processing; (v) calculating static relevancy; (vi) clustering the advertisements; (vii) validation of the cluster volume and (viii) serialization of the processed partitions.

The indexer 134 then performs a method of incremental indexing. Generally speaking, when performing incremental indexing, the indexer 134 causes only indexes associated with the updated partitions to be updated. In other words, rather than re-indexing the whole of the persistent index 300′, the indexer 134 causes only indexes associated with the first partition 302′ and the third partition 306′ to be re-indexed.

Much akin to what was described above, the indexer 134 transmits the updated ones of the first partition 302′ and the third partition 306′ to the index receiver 142. Once the indexer 134 has completed processing the data stored in the persistent storage 300, it transmits it to a search machine 140 and, namely, to an index receiver 142 of the search machine 140. The index receiver 142 processes the received updated partitions and determines which persistent indexes stored in the index storage 144 need to be updated. The index receiver 142 then transcodes the received updated partitions into the search index format. Once transcoded, the index receiver 142 then accesses the search index for the updated partitions in the index storage 144 and updates the portions of the search index associated with the updated partitions.

Much akin to the partitioner 104 only updating those partitions that need to be updated, the index receiver 142 also updates only those portions of the search index that need to be updated (due to the changes in the updated partitions). It can be said that in some non-limiting embodiments of the present technology, a technical effect can be enjoyed, the technical effect being associated with the ability to manage an ever increasing number of advertisement contained in the ever increasing number of partner feeds (it is said that the number is increasing at a rate of 30 to 50 per cent per annum). Additional or alternatively, another technical effect may be associated with the ability to index the updated feeds relatively faster due at least partially to the fact that only those partitions that need to be updated are updated and that only those portions of the persistent index associated with the updated feeds are re-indexed.

In some non-limiting embodiments of the present technology, the number of indexers 134 can be increased. This is particularly convenient, where the number of partner feeds to be processed (i.e., parsed and then indexed) is large. As has been mentioned, within these embodiments, the partitioner 104 can load balance which indexer 134 is responsible for the preparation of the updated partner feeds for indexing. In some non-limiting embodiments of the present technology, as the number of the updated partner feeds increases—the partitioner 104 may create additional partitions—i.e. the ones beyond the first partition 202, the second partition 204 and the third partition 206. For example, in some implementations of the present technology, it may be decided to keep each partition of the first partition 202, the second partition 204 and the third partition 206 to a size of less than ten or twenty advertisements each (or any other number, as may be chosen by the operator of the feed indexing device 102). It should be noted that a technical effect associated with keeping the partitions to a certain number of entries may include increased speed of indexing (or re-indexing).

It is expected that those skilled in the art, given the above description, will be easily able to implement non-limiting embodiments of the present technology. However, for the purposes of illustration, some specific examples of implementational details will be presented.

In some non-limiting embodiments of the present technology, portions of the feed processing device 102 are executed using Scala and Java programming languages. Some of the processes executed within the feed processing device 102 are executed using Spring. Indexing processes can be implemented using Throughput GC. The oversight and overall management of the processes within the feed processing device 102 can be implemented using instrumental components Akka, Jetty, Apache HTTP Client and the like.

In some non-limiting embodiments of the present technology, the partitioner 104 and the indexer 134 can communicate using Akka protocol, using akka-remote module of the protocol. The indexer 134, the index receiver 142 and the auxiliary information device 152 can communicate using ZeroMQ publish-subscribe (over TCP). Some or all of data stored in various databases can be serialized using Protocol Buffers.

Naturally, any other suitable protocol, programming languages, stack implementations, hardware, software and/or firmware can be used to implement embodiments of the present technology. Also, it should be understood that even though some components of the feed processing device 102 have been depicted as separate entities, in alternative non-limiting embodiments of the present technology, functionality of some or all of the components of the feed processing device 102 can be combined. For example, the functionality of the partitioner 104 and the indexer 134 can be combined and hosted on a single device.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of operating a partner feed index, the method executable at a server, the method comprising:
receiving an updated-partner-feed, the updated-partner-feed representing a given item;
parsing the updated-partner-feed into key fields, the key fields being representative of a characteristic of the given item;
accessing a processed-partner-feeds-database, the processed-partner-feeds-database comprising a single persistent storage, the persistent storage comprising a plurality of partitions associated with a subject, each of the partition grouping a specific item associated with the subject;
determining a given partition associated with the given item the given partition including a first-prior-partner-feed and a second-prior-partner-feed, each of the first-prior-partner-feed and the second-prior-partner-feed representing a same item as of the given item, the first-prior-partner-feed and the second-prior-partner-feed having been grouped into the given partition based on a characteristic shared by the first-prior-partner-feed and the second-prior-partner-feed; and,
responsive to the updated-partner-feed being indicative of a difference with the first-prior-partner-feed and the second-prior-partner-feed, updating only the given partition based on the updated-partner-feed without updating other partitions stored in the persistent storage.

2. The method of claim 1, further comprising updating a search index based on the updated partition.

3. The method of claim 2, wherein said updating a search index comprises determining a portion of the search index associated with the updated portion of the partition.

4. The method of claim 3, wherein said updating a search index comprises only re-indexing said portion of the search index associated with the updated portion of the partition.

5. The method of claim 3, further comprising preparing the updated portion of the partition for indexing prior to said updating a search index.

6. The method of claim 5, wherein said preparing comprises one or more of: (i) de-serializing; (ii) unifying; (iii) validating the partition by checking against business logic; (iv) image processing; (v) calculating static relevancy; (vi) clustering the advertisements; (vii) validation of the cluster volume and (viii) serialization of the processed partitions.

7. The method of claim 5, wherein said preparing comprises de-serializing the updated-partner-feed and wherein said de-serializing comprises converting the updated-partner-feed from a first format to a second format.

8. The method of claim 5, wherein said preparing comprises unifying key fields within the updated-partner-feed.

9. The method of claim 5, wherein said preparing comprises validating the updated-partner-feed by checking against a business logic.

10. The method of claim 5, wherein said preparing comprises image processing.

11. The method of claim 10, wherein said image processing comprises re-sizing images contained within the updated-partner-feed.

12. The method of claim 5, wherein said preparing comprises calculating static relevancy.

13. The method of claim 5, wherein said processing comprises checking the updated-partner-feed, the first-prior-partner-feed and the second-prior-partner-feed for duplicates.

14. The method of claim 5, wherein said processing comprises validating the size of the partition.

15-16. (canceled)

17. The method of claim 1, wherein said parsing comprises executing a unification function.

18. The method of claim 1, wherein said updating the partition based on the updated-partner-feed comprises only updating the portion of the partition associated with the updated-partner-feed.

19. The method of claim 1, wherein the characteristic shared by the first-prior-partner-feed and the second-prior-partner-feed is determined based on the key fields associated with the first-prior-partner-feed and the second-prior-partner-feed.

20. The method of claim 1, wherein where the updated-partner-feed is being indicative of one of the first-prior-partner-feed and the second-prior-partner-feed being no longer active, said updating comprises removing the respective one of the first-prior-partner-feed and the second-prior-partner-feed.

21. The method of claim 1, wherein where the updated-partner-feed is being indicative of a new partner feed being different from the first-prior-partner-feed and the second-prior-partner-feed, said updating comprises creating a new partner feed in the partition containing the first-prior-partner-feed and the second-prior-partner-feed.

22. The method of claim 1, wherein where the updated-partner-feed is being indicative of one of the first-prior-partner-feed and the second-prior-partner-feed having been changed, said updating comprises updating the respective one of the first-prior-partner-feed and the second-prior-partner-feed.

23. (canceled)

24. The method of claim 1, wherein the given item is representative of an advertisement.

25. A system for operating a partner feed index, system comprising:
a feed processing apparatus configured to:
receive an updated-partner-feed, the updated-partner-feed representing a given item;
parse the updated-partner-feed into key fields, the key fields being representative of a characteristic of the given item;
access a processed-partner-feeds-database, the processed-partner-feeds-database comprising a single persistent storage, the persistent storage comprising a plurality of partitions associated with a subject, each of the partition grouping a specific item associated with the subject;
determine a given partition associated with the given item, the given partition including a first-prior-partner-feed and a second-prior-partner-feed, each of the first-prior-partner-feed and the second-prior-partner-feed representing a same item as of the given item, the first-prior-partner-feed and the second-prior-partner-feed having been grouped into the given partition based on a characteristic shared by the first-prior-partner-feed and the second-prior-partner-feed;
responsive to the updated-partner-feed being indicative of a difference with the first-prior-partner-feed and the second-prior-partner-feed, update only the given partition based on the updated-partner-feed without updating other partitions stored in the persistent storage.

26-48. (canceled)
